(19) United States
(12) Patent Application Publication
(10) Pub. No.: US 2016/0294769 A1
(43) Pub. Date: Oct. 6, 2016

(54) Communication Method, Apparatus, and System of Virtual Extensible Local Area Network

(71) Applicant: Huawei Technologies Co., Ltd., Shenzhen (CN)

(72) Inventors: Yu Song, Shenzhen (CN); Zhiqiang Xiong, Shenzhen (CN)

(21) Appl. No.: 15/176,854

(22) Filed: Jun. 8, 2016

Related U.S. Application Data
(63) Continuation of application No. PCT/CN2013/089149, filed on Dec. 11, 2013.

(51) Int. Cl. H04L 29/12; H04L 12/18; H04L 12/46

(52) U.S. Cl. CPC H04L 61/2015; H04L 12/4641; H04L 12/4633; H04L 12/18; H04L 61/106

(57) ABSTRACT

A communication method includes a transmit-end tunnel end points (VTEP) may intercept a broadcast packet that does not have a destination address and that is sent by a transmit-end virtual machine, acquire an Internet Protocol (IP) address list of a receive-end VTEP that belongs to same virtual extensible local area network (VXLAN) as the transmit-end VTEP, encapsulate the broadcast packet into a unicast packet according to an IP address of the receive-end VTEP, and send, in a form of the unicast packet, the original packet to another receive-end VTEP on the same VXLAN, where avoiding using a multicast manner to perform communication between VTEPs on the VXLAN such that construction of the VXLAN no longer depends on a multicast group quantity or capability of a tunnel end point, which extends application of the VXLAN.

### CROSS-REFERENCE TO RELATED APPLICATIONS

This application is a continuation of International Application No. PCT/CN2013/089149, filed on Dec. 11, 2013, which is hereby incorporated by reference in its entirety.

### TECHNICAL FIELD

Embodiments of the present disclosure relate to communications technologies, and in particular, to a communication method, apparatus, and system of a virtual extensible local area network.

### BACKGROUND

With the widespread application of a virtualization technology, virtual local area network (VLAN) space on a data center network cannot meet requirements of the data center network on a VLAN. A virtual extensible local area network (VXLAN) technology extends network virtualization, to obtain a sufficient quantity of virtual networks in order to meet user requirements.

On a VXLAN, a virtualized layer 2 network is constructed on a physical layer 3 network using a tunneling port technology at a source virtual machine end, and a large quantity of VXLANs are created on an existing network architecture. Different VXLANs are identified by VXLAN network identifiers (VNIs). Each VNI may include a maximum of 4094 VLANs, which extends a quantity of VLANs.

An existing communication mode of the VXLAN is a tunnel end point (VTEP) to which each virtual machine belongs implements, in a protocol independent multicast (PIM) multicast manner, learning of a media access control (MAC) address of a destination virtual machine and an Internet Protocol (IP) address of the tunnel end point. After receiving a packet, a VTEP of a source virtual machine constructs an Internet group management protocol (IGMP) packet, and then sends, in the PIM multicast manner, the IGMP packet to a destination VTEP corresponding to a destination virtual machine (VM). If the destination VTEP receives the IGMP packet, the destination VTEP parses the IGMP packet, and broadcasts a parsing result to the destination VM corresponding to the destination VTEP. A PIM multicast specification of a tunnel end point is relatively small, where 500 to 2000 multicast groups are generally supported. In addition, some tunnel end points may not support PIM multicast. However, the VXLAN may support 16 million VNIs according to a standard. Therefore, on the existing VXLAN network, because a quantity of multicast groups of tunnel end points is insufficient or multicast is not supported, a quantity of created VNIs is limited, which affects a quantity of VLANs created on a data center network. In addition, a tunnel end point performs communication on a VLAN in a multicast manner, which needs to use relatively much network traffic and occupies relatively many network resources.

### SUMMARY

Embodiments of the present disclosure put forward a communication method, apparatus, and system of a VXLAN, which can avoid using a multicast manner to perform communication between VTEPs on a VXLAN network.

According to a first aspect, an embodiment of the present disclosure puts forward a communication method of a VXLAN, where the VXLAN includes a VXLAN centralized controller and multiple VTEPs, and the method includes intercepting, by a transmit-end VTEP, a broadcast packet sent by a transmit-end virtual machine, determining, by the transmit-end VTEP, whether the broadcast packet does not have a destination address, and if determining that the broadcast packet does not have a destination address, acquiring, by the transmit-end VTEP, from the VXLAN centralized controller, an IP address of a receive-end VTEP on the VXLAN, and encapsulating, by the transmit-end VTEP, the broadcast packet into a unicast packet according to the IP address of the receive-end VTEP, and sending the unicast packet to the receive-end VTEP such that the receive-end VTEP broadcasts the received unicast packet to a receive end.

With reference to the first aspect, in a first possible implementation manner, the transmit-end VTEP sends a query request to the VXLAN centralized controller, and the transmit-end VTEP receives a query response returned by the VXLAN centralized controller, where the query response carries IP addresses of all VTEPs on the VXLAN.

With reference to the first aspect, in a second possible implementation manner, acquiring, by the transmit-end VTEP, from the VXLAN centralized controller, an IP address of a receive-end VTEP on the VXLAN includes sending, by the transmit-end VTEP, a query request to the VXLAN centralized controller, and receiving, by the transmit-end VTEP, a query response returned by the VXLAN centralized controller, where the query response carries IP addresses of multiple receive-end VTEPs on the VXLAN, and the multiple receive-end VTEPs are obtained by the VXLAN centralized controller from all VTEPs on the VXLAN by means of screening according to a type of the broadcast packet or location information of the transmit-end VTEP.

With reference to the first aspect or the first or the second possible implementation manner of the first aspect, in a third possible implementation manner, the broadcast packet is a gratuitous address resolution protocol (ARP) broadcast packet, and the method further includes reporting, by the transmit-end VTEP, to the VXLAN centralized controller, a source IP address and a source MAC address that are carried by the gratuitous ARP broadcast packet.

With reference to the first aspect or the first or the second possible implementation manner of the first aspect, in a fourth possible implementation manner, the broadcast packet is a dynamic host configuration protocol (DHCP) broadcast packet, and the method further includes intercepting, by the transmit-end VTEP, a response packet sent by a DHCP server in response to the unicast packet, where the response packet carries an IP address assigned by the DHCP server to the transmit-end virtual machine and a MAC address, and reporting, by the transmit-end VTEP, to the VXLAN centralized controller, the IP address newly assigned to the transmit-end virtual machine and the MAC address.

According to a second aspect, an embodiment of the present disclosure puts forward a communication method of a VXLAN, where the VXLAN includes a VXLAN centralized controller and multiple VTEPs, and the method includes receiving, by the VXLAN centralized controller, a query request sent by a transmit-end VTEP, where the query request is sent to the VXLAN centralized controller after the transmit-end VTEP intercepts a broadcast packet sent by a transmit-end virtual machine and determines that the broadcast packet does not have a destination address, and the query request carries an identifier of the VXLAN on which the transmit-end VTEP is located, determining, by the VXLAN centralized controller, an IP address of a receive-end VTEP on the VXLAN according to the identifier of the VXLAN, and sending, by the VXLAN centralized controller, a query response to the transmit-end VTEP, where the query response carries the IP address of the receive-end VTEP such that the transmit-end VTEP encapsulates the broadcast packet into a unicast packet according to the IP address of the receive-end VTEP, and sends the unicast packet to the receive-end VTEP.

With reference to the second aspect, in a first possible implementation manner, the method further includes pre-configuring, by the VXLAN centralized controller, a correspondence between the identifier of the VXLAN network and IP addresses of all VTEPs on the VXLAN network, and accordingly, querying, by the VXLAN centralized controller, the correspondence according to the identifier of the VXLAN, determining the IP addresses of all the VTEPs on the VXLAN, and sending a query response to the transmit-end VTEP, where the query response carries the IP addresses of all the VTEPs.

With reference to the second aspect, in a second possible implementation manner, the method further includes determining, by the VXLAN centralized controller, a type of the broadcast packet, and obtaining, by means of screening according to the type of the broadcast packet or location information of the transmit-end VTEP, multiple receive-end VTEPs from all the VTEPs on the VXLAN.

With reference to the second aspect or the first or the second possible implementation manner of the second aspect, in a third possible implementation manner. The broadcast packet is a gratuitous ARP broadcast packet, and the method further includes receiving, by the VXLAN centralized controller, a source IP address and a source MAC address that are carried by the gratuitous ARP broadcast packet and that are reported by the transmit-end VTEP, and storing, by the VXLAN centralized controller, the source IP address and the source MAC address.

With reference to the second aspect or the first or the second possible implementation manner of the second aspect, in a fourth possible implementation manner, the method further includes the broadcast packet that is a DHCP broadcast packet, and the method further includes receiving, by the VXLAN centralized controller, an IP address assigned by a DHCP server to the transmit-end virtual machine and a MAC address that are reported by the transmit-end VTEP, and storing, by the VXLAN centralized controller, the IP address newly assigned to the transmit-end virtual machine and the MAC address.

According to a third aspect, an embodiment of the present disclosure puts forward a communications system of a VXLAN, where the VXLAN includes a VXLAN centralized controller and multiple VTEPs, and each VTEP and at least one virtual machine managed by the VTEP form a subnet of the VXLAN, where a transmit-end VTEP is configured to intercept a broadcast packet sent by a transmit-end virtual machine, determine whether the broadcast packet does not have a destination address, and acquire, from the VXLAN centralized controller, an IP address of a receive-end VTEP on the VXLAN if determining that the broadcast packet does not have a destination address, encapsulate the broadcast packet into a unicast packet according to the IP address of the receive-end VTEP, and send the unicast packet to the receive-end VTEP. The VXLAN centralized controller is configured to receive a query request sent by the transmit-end VTEP, determine the IP address of the receive-end VTEP on the VXLAN, and send a query response to the transmit-end VTEP, where the query response carries the IP address of the receive-end VTEP, and the receive-end VTEP is configured to receive the unicast packet sent by the transmit-end VTEP, and broadcast the received unicast packet to a receive end.

According to a fourth aspect, an embodiment of the present disclosure puts forward a communications apparatus of a VXLAN, where the VXLAN includes a VXLAN centralized controller and multiple VTEPs, and the VTEP includes an interception unit configured to intercept a broadcast packet sent by a transmit-end virtual machine, a determining unit configured to determine whether the broadcast packet does not have a destination address, and acquire, from the VXLAN centralized controller, an IP address of a receive-end VTEP on the VXLAN if determining that the broadcast packet does not have a destination address, and a sending unit configured to encapsulate the broadcast packet into a unicast packet according to the IP address of the receive-end VTEP, and send the unicast packet to the receive-end VTEP such that the receive-end VTEP broadcasts the received unicast packet to a receive end.

According to a fifth aspect, an embodiment of the present disclosure puts forward a communications apparatus of a VXLAN, where the VXLAN includes a VXLAN centralized controller and multiple VTEPs, and the VXLAN centralized controller includes a receiving unit configured to receive a query request sent by a transmit-end VTEP, where the query request is sent to the VXLAN centralized controller after the transmit-end VTEP intercepts a broadcast packet sent by a transmit-end virtual machine and determines that the broadcast packet does not have a destination address, and the query request carries an identifier of the VXLAN on which the transmit-end VTEP is located, a determining unit configured to determine an IP address of a receive-end VTEP on the VXLAN according to the identifier of the VXLAN, and a sending unit configured to send a query response to the transmit-end VTEP, where the query response carries the IP address of the receive-end VTEP such that the transmit-end VTEP encapsulates the broadcast packet into a unicast packet according to the IP address of the receive-end VTEP, and sends the unicast packet to the receive-end VTEP.

According to the method, the apparatus, and the system provided in the embodiments of the present disclosure, a transmit-end VTEP can intercept a broadcast packet that does not have a destination address and that is sent by a transmit-end virtual machine, acquire an IP address list of a receive-end VTEP that belongs to a same VXLAN network as the transmit-end VTEP, encapsulate the broadcast packet into a unicast packet according to an IP address of the receive-end VTEP, and send, in a form of a unicast packet, an original packet in a form of the unicast packet, the original packet to another receive-end VTEP on the same VXLAN network. This can avoid using a multicast manner to perform communication between VTEPs on the VXLAN network such that construction of the VXLAN network no longer depends on a multicast group quantity or multicast capability of a tunnel end point, which extends application of the VXLAN network.

### BRIEF DESCRIPTION OF DRAWINGS

To describe the technical solutions in the embodiments of the present disclosure more clearly, the following briefly introduces the accompanying drawings required for describing the embodiments. The accompanying drawings in the following description show merely some embodiments of the present disclosure, and persons of ordinary skill in the art may still derive other drawings from these accompanying drawings without creative efforts.

FIG. 1 is a diagram of composition of a data center network according to an embodiment of the present disclosure;

FIG. 2 is a flowchart of a method according to an embodiment of the present disclosure;

FIG. 3 is a flowchart of another method according to an embodiment of the present disclosure;

FIG. 4 is a flowchart of another method according to an embodiment of the present disclosure;

FIG. 5 is a diagram of composition of a communications apparatus of a VXLAN according to an embodiment of the present disclosure;

FIG. 6 is a diagram of composition of another communications apparatus of a VXLAN according to an embodiment of the present disclosure; and

FIG. 7 is a diagram of composition of a computer according to an embodiment of the present disclosure.

### DESCRIPTION OF EMBODIMENTS

Embodiments of the present disclosure put forward a communication method, apparatus, and system of a VXLAN, which can avoid using a multicast manner to perform communication between VTEPs on a VXLAN network such that construction of the VXLAN network no longer depends on a multicast group quantity or capability of a tunnel end point, which extends application of the VXLAN network.

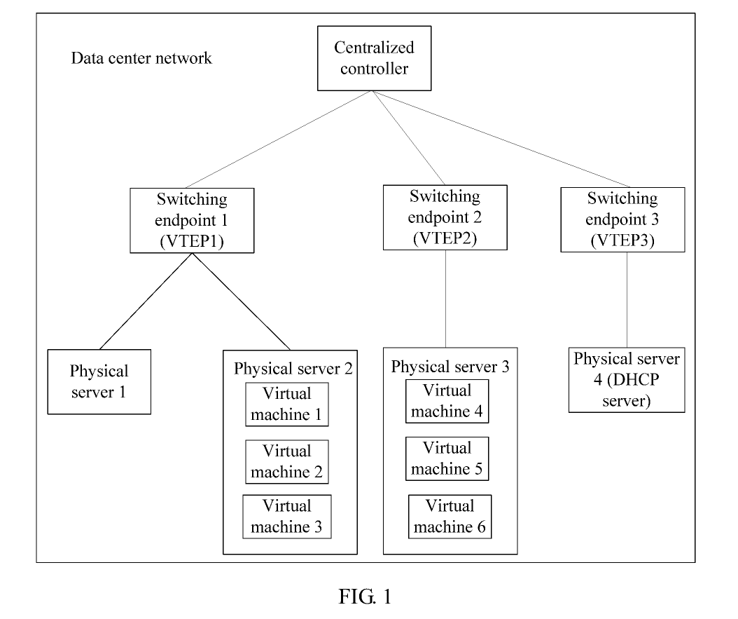

FIG. 1 is an architecture diagram of a data center network provided in an embodiment of the present disclosure. In FIG. 1, physical servers 1 to 4, a switching endpoint 1 (including VTEP1), a switching endpoint 2 (including VTEP2), and a switching endpoint 3 (including VTEP3) are located on one VXLAN network. The physical servers 2 and 3 include multiple virtual machines each, where the physical server 2 abstracts virtual machines 1, 2, and 3, and the physical server 3 abstracts virtual machines 4, 5, and 6. The physical server 4 is a DHCP server and is configured to dynamically assign IP addresses to nodes on the network. The switching endpoint 1, the physical server 1, and the virtual machines in the physical server 2 constitute one subnet of the VXLAN network, the switching endpoint 2 and the virtual machines in the physical server 3 constitute another subnet of the VXLAN network, and the switching endpoint 3 and the physical server 4 constitute another subnet of the VXLAN network. A VTEP on each switching endpoint is configured to provide encapsulation and decapsulation capabilities for each host node on a VXLAN subnet to which the VTEP belongs, and record an identifier of a VXLAN subnet to which each host node belongs. In this embodiment, when host nodes on a subnet on which a VTEP is located are all virtual machines, each VTEP manages the virtual machines on the subnet on which the VTEP is located.

In this embodiment of the present disclosure, a VXLAN centralized controller is further set on the VXLAN network, where the centralized controller stores a VNI of each host node (the host node in this embodiment of the present disclosure may be a physical machine or may be a virtual machine) on the VXLAN, and a correspondence between an address of each host node and an address of a VTEP corresponding to the host node, where the address may be an IP address and/or a MAC address. When a host node is started, a correspondence between a MAC address of each host node and an IP address of a VTEP corresponding to the host node is updated to the VXLAN centralized controller. When the host node needs to communicate with another host node, a switching endpoint on which the host node is located obtains, by querying the VXLAN centralized controller, a MAC address of a destination host, and an IP address and a MAC address of a VTEP of a switching endpoint to which the destination host is connected in order to implement communication. Further, the VXLAN centralized controller may further record a correspondence between an IP address and a MAC address of each host node.

In this embodiment of the present disclosure, an example in which a host node is a virtual machine is used.

In a virtualization scenario, a virtual machine is often migrated dynamically. If migration across layer 2 occurs, an IP address of the virtual machine needs to be changed. When the IP address of the virtual machine changes dynamically, some broadcast packets that do not have a destination address are generated, for example, a DHCP broadcast packet that is used to request a DHCP server on which migration occurs to assign a new IP address to a virtual machine on which migration occurs, or a gratuitous ARP broadcast packet that is used to notify another host node on a same VXLAN network of a changed address of the local end. If this type of broadcast packet that does not have a destination address is sent in a multicast manner according to the prior art, a problem that a quantity of multicast groups of tunnel end points is insufficient or multicast is not supported may occur. According to this embodiment of the present disclosure, a broadcast packet that does not have a destination address can be converted into a unicast packet for forwarding.

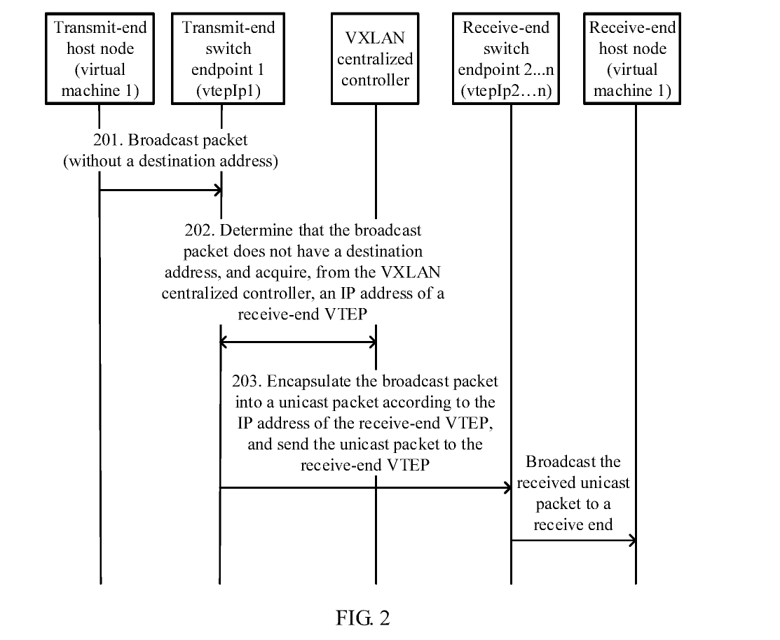

With reference to a system shown in FIG. 1, as shown in FIG. 2, a communication method of a VXLAN provided in an embodiment of the present disclosure includes the following steps.

Step 201: A transmit-end VTEP intercepts a broadcast packet sent by a transmit-end virtual machine.

Further, after a virtual machine 1 sends a broadcast packet that does not have a destination address, a VTEP1 on a subnet on which the virtual machine 1 is located no longer uses, after receiving the broadcast packet, a multicast manner to send the broadcast packet.

Step 202: The transmit-end VTEP determines whether the broadcast packet does not have a destination address, and if determining that the broadcast packet does not have a destination address, the transmit-end VTEP acquires, from the VXLAN centralized controller, an IP address of a receive-end VTEP on the VXLAN.

Furthermore, the VTEP1 sends a query request to the VXLAN centralized controller, where the query request carries an VNI of the VXLAN network on which the virtual machine 1 is located, and the VXLAN centralized controller acquires, according to the VNI, an IP address list of the receive-end VTEP on the VXLAN network, and returns the IP address list of the receive-end VTEP to the VTEP1.

Preferably, the VXLAN controller may determine an IP address list of multiple receive-end VTEPs on the VXLAN network, and return the IP address list of the multiple receive-end VTEPs to the VTEP1.

Preferably, determining of the multiple receive-end VTEPs on the VXLAN network may be relatively flexible. For example, the multiple receive-end VTEPs may be all VTEPs on the VXLAN, VTEPs that are recorded in the centralized controller, VTEPs currently in an active state that are determined by the centralized controller, a VTEP that is determined by the centralized controller according to a preset selection policy and whose location is close to a location of a VTEP on which a source virtual machine is located, or a VTEP obtained by means of screening according to a type of a broadcast packet.

Step 203: The transmit-end VTEP encapsulates the broadcast packet into a unicast packet according to the IP address of the receive-end VTEP, and sends the unicast packets to the receive-end VTEP such that the receive-end VTEP broadcasts the received unicast packet to a receive end.

Preferably, the transmit-end VTEP encapsulates the broadcast packet into multiple unicast packets according to the IP addresses of the multiple receive-end VTEPs, and sends the multiple unicast packets to the receive-end VTEPs respectively such that each receive-end VTEP broadcasts the received unicast packet to a receive end if addresses of multiple receive-end VTEPs are returned.

Furthermore, the VTEP1 encapsulates content of the broadcast packet and the IP address of each receive-end VTEP into one unicast packet, where each unicast packet is corresponding to one receive-end VTEP, and sends, to each receive-end VTEP, a unicast packet corresponding to the address of the receive-end VTEP. Each receive-end VTEP broadcasts the unicast packet to each host node on a subnet on which the receive-end VTEP is located after receiving the unicast packet.

According to this embodiment of the present disclosure, a transmit-end VTEP can intercept a broadcast packet that does not have a destination address and that is sent by a transmit-end virtual machine, acquire an IP address list of a receive-end VTEP that belongs to a same VXLAN as the transmit-end VTEP, encapsulate the broadcast packet into a unicast packet according to an IP address of the receive-end VTEP, and send, in a form of the unicast packet, the original packet to another receive-end VTEP on the same VXLAN. This can avoid using a multicast manner to perform communication between VTEPs on the VXLAN such that construction of the VXLAN no longer depends on a multicast group quantity or capability of a tunnel end point, which extends application of the VXLAN.

In addition, when the IP address list of the multiple receive-end VTEPs returned by the centralized controller is an IP address list of all VTEPs on the VXLAN network, it can be ensured that the broadcast packet is sent to a receive end that should receive the broadcast packet, thereby ensuring correctness of sending and receiving. When the VXLAN centralized controller further parses the broadcast packet, and selects multiple receive-end VTEPs according to a parsing result and a preset selection policy, for example, selecting receive-end VTEPs according to location information, activation information, or a type of the broadcast packet, it is ensured that unicast sending is performed accordingly after a sending manner is changed from broadcast to unicast, thereby avoiding waste of resources.

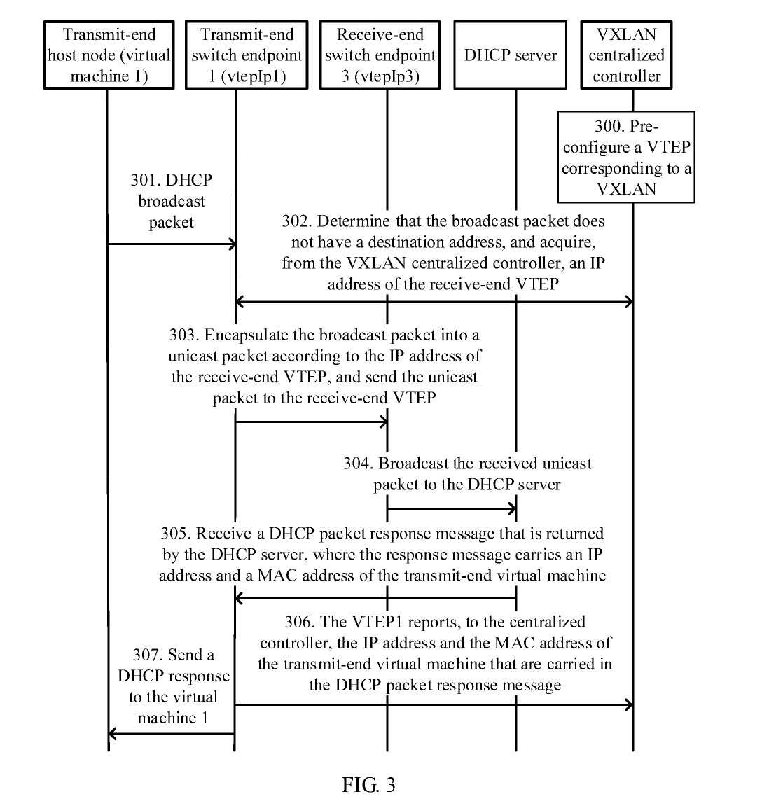

As shown in FIG. 3, the broadcast packet is a DHCP broadcast packet. After migration occurs on a virtual machine 1, the virtual machine 1 originates a DHCP broadcast packet, to request a DHCP server on a network to assign a new IP address to the virtual machine 1. A communication method of a VXLAN provided in an embodiment of the present disclosure includes the following steps.

Step 300: Pre-configure a VTEP corresponding to a VXLAN in a VXLAN centralized controller.

A correspondence between an identifier of the VXLAN and IP addresses of all VTEPs on the VXLAN is pre-configured in the VXLAN centralized controller.

Step 301: A virtual machine 1 originates a DHCP broadcast packet, and a transmit-end VTEP1 intercepts the DHCP broadcast packet, where the DHCP broadcast packet does not include a destination IP address.

Furthermore, after the virtual machine 1 sends the broadcast packet that does not have a destination address, the VTEP1 on a subnet on which the virtual machine 1 is located no longer uses, after receiving the broadcast packet, a multicast manner to send the broadcast packet, which is referred to as “intercepting the broadcast packet” in this embodiment of the present disclosure.

Step 302: A transmit-end VTEP1 determines whether the DHCP broadcast packet includes a destination IP address, and if the DHCP broadcast packet does not include a destination IP address, the transmit-end VTEP1 acquires, from the VXLAN centralized controller, an IP address of a receive-end VTEP on a VXLAN on which the virtual machine 1 is located, that is, an IP address of a VTEP3 on a subnet on which a DHCP server is located.

Further, the transmit-end VTEP1 sends a query request to the VXLAN centralized controller, where the query request carries a VNI of the VXLAN on which the virtual machine 1 is located, and the VXLAN centralized controller queries, according to the VNI, the pre-configured correspondence, and acquires an IP address list, stored in the correspondence, of all VTEPs on the VXLAN.

The VXLAN centralized controller may return, to the VTEP1, the IP address list of all VTEPs that is configured in the correspondence. The VXLAN centralized controller may further analyze location information of the transmit-end VTEP1 (for example, analyzing an IP address of the VTEP1), determine a receive-end VTEP whose location is close to a location of the transmit-end VTEP1, and return, to the transmit-end VTEP1, an IP address list of the determined receive-end VTEP whose location is close to the location of the transmit-end VTEP1. The VXLAN centralized controller may further analyze a type of the broadcast packet, further obtain a receive-end VTEP by means of screening according to the type of the broadcast packet, and return, to the transmit-end VTEP1, an IP address list of the receive-end VTEP obtained by means of screening. In this embodiment, the VXLAN centralized controller analyzes the DHCP broadcast packet request, obtains, by means of screening, a receive-end VTEP3 that manages the DHCP server on the VXLAN network, and returns, to the VTEP1, the IP address of the receive-end VTEP3 obtained by means of screening.

Step 303: The transmit-end VTEP1 encapsulates the broadcast packet into a unicast packet according to the IP address of the VTEP3 on which the DHCP server is located, and sends the unicast packet to the VTEP3 on which the DHCP server is located.

Step 304: The VTEP3 on which the DHCP server is located forwards the DHCP packet request to the DHCP server, and the receive-end VTEP3 on which the DHCP server is located receives a DHCP packet response message, where the DHCP packet response message carries an IP address that is newly assigned by the DHCP server to a transmit-end virtual machine and a MAC address of the transmit-end virtual machine, and forwards the received DHCP packet response message to the VTEP1.

Step 305: The transmit-end VTEP1 receives the DHCP packet response message sent by the DHCP server, where the DHCP packet response message carries the IP address, assigned by the DHCP server, of the transmit-end virtual machine and the MAC address.

Step 306: The transmit-end VTEP1 intercepts the DHCP packet response message, and reports the IP address and the MAC address of the transmit-end virtual machine to the VXLAN centralized controller such that the VXLAN centralized controller stores the IP address and the MAC address of the transmit-end virtual machine.

Step 307: The transmit-end VTEP1 returns the DHCP packet response message to the virtual machine 1, to notify the virtual machine 1 of the newly assigned IP address.

According to this embodiment of the present disclosure, a transmit-end VTEP1 can intercept a DHCP broadcast packet request that does not have a destination address and that is sent by a transmit-end virtual machine, acquire an IP address of a receive-end VTEP that belongs to a same VXLAN as the transmit-end VTEP1, encapsulate the broadcast packet into a unicast packet according to an IP address of the receive-end VTEP, and send, in a form of the unicast packet, the original packet to a receive-end VTEP that manages a DHCP server. This can avoid using a multicast manner to perform communication between VTEPs on the VXLAN such that construction of the VXLAN no longer depends on a multicast group quantity or capability of a tunnel end point, which extends application of the VXLAN. Further, in this embodiment, the transmit-end VTEP1 may further intercept a DHCP packet response message, and report, to a VXLAN centralized controller for storage, an IP address and a MAC address of a transmit-end virtual machine that are carried by the packet response message such that the VXLAN centralized controller stores updated information, which ensures correctness of information and ensures efficient implementation of subsequent communication.

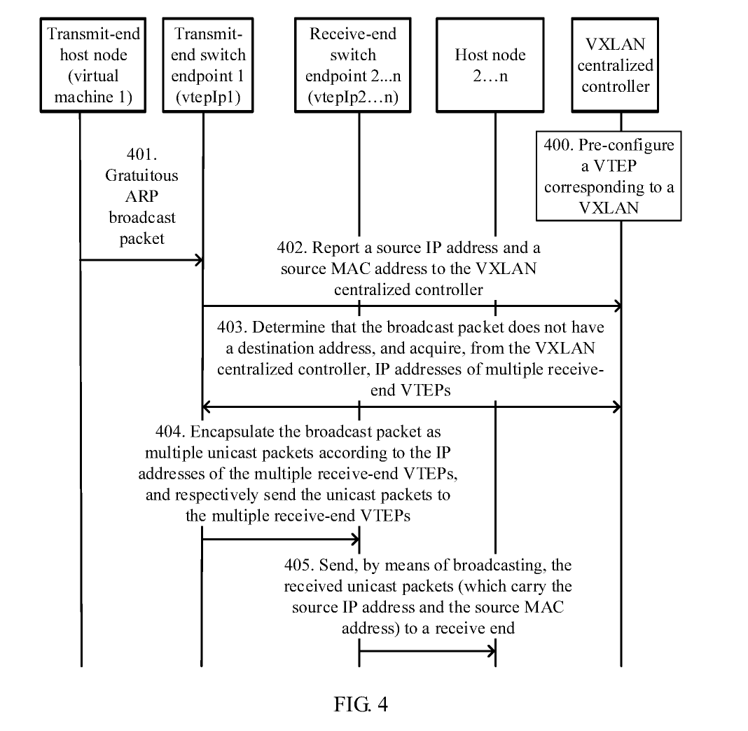

As shown in FIG. 4, the broadcast packet is a gratuitous ARP broadcast packet. After migration occurs on a virtual machine 1, the virtual machine 1 originates a DHCP broadcast packet and acquires a new IP address, and the virtual machine 1 originates a gratuitous ARP packet, where the gratuitous ARP packet carries a MAC address of the virtual machine 1 and a newly assigned IP address in order to notify another host node of the MAC address of the virtual machine 1 and the newly assigned IP address. A communication method of a VXLAN provided in an embodiment of the present disclosure includes the following steps.

Step 400: Pre-configure a VTEP corresponding to a VXLAN for the VXLAN in a VXLAN centralized controller.

Further, a correspondence between an VNI of the VXLAN and an IP address of a VTEP configured on the VXLAN is pre-configured in the VXLAN centralized controller.

Step 401: A transmit-end virtual machine 1 originates a gratuitous ARP broadcast packet, and a transmit-end VTEP1 intercepts the gratuitous ARP broadcast packet, where the gratuitous ARP broadcast packet includes a source IP address and a source MAC address but does not include a destination IP address.

Further, after the transmit-end virtual machine 1 sends a broadcast packet that does not have a destination address, a VTEP1 on a subnet on which the transmit-end virtual machine 1 is located no longer uses, after receiving the broadcast packet, a multicast manner to send the broadcast packet, which is referred to as “intercepting a broadcast packet” in this embodiment of the present disclosure.

Step 402: The transmit-end VTEP1 determines that the gratuitous ARP broadcast packet includes a source address but does not include a destination address, and reports the source IP address and the source MAC address to the VXLAN centralized controller.

Further, the transmit-end VTEP1 reports the source IP address and the source MAC address to the VXLAN centralized controller such that the VXLAN centralized controller establishes a correspondence between the source IP address and the source MAC address, and stores the correspondence.

Step 403: The transmit-end VTEP1 acquires, from the VXLAN centralized controller, IP addresses of multiple VTEPs on a VXLAN on which the virtual machine 1 is located.

Further, the transmit-end VTEP1 sends a query request to the VXLAN centralized controller, where the query request carries an VNI of the VXLAN on which the transmit-end virtual machine 1 is located, and the VXLAN centralized controller queries, according to the VNI, the pre-configured correspondence, and acquires an IP address list, stored in the correspondence, of a VTEP that has been configured on the VXLAN. In this embodiment, the VXLAN centralized controller may return, to the transmit-end VTEP1, an IP address list of all VTEPs that is configured in the correspondence.

Step 404: The transmit-end VTEP1 encapsulates the gratuitous ARP broadcast packet into a unicast packet, and sends the unicast packet to each receive-end VTEP of the multiple receive-end VTEPs.

Further, the VTEP1 encapsulates content of the gratuitous ARP broadcast packet and the IP address of each receive-end VTEP into one unicast packet, where each unicast packet is corresponding to one receive-end VTEP, and sends, to each receive-end VTEP, a unicast packet corresponding to the address of the receive-end VTEP. Each receive-end VTEP broadcasts the unicast packet to each host node on a subnet on which the receive-end VTEP is located after receiving the unicast packet.

Step 405: Each receive-end VTEP sends, by means of broadcasting, the unicast packet to a virtual machine managed by the receive-end VTEP, to notify the virtual machine managed by the receive-end VTEP of a new IP address and a MAC address of the virtual machine 1.

According to this embodiment of the present disclosure, a transmit-end VTEP1 can intercept a gratuitous ARP broadcast packet that does not have a destination address and that is sent by a virtual machine, acquire IP addresses of all VTEPs that belong to a same VXLAN as a transmit-end VTEP1, encapsulate the broadcast packet into a unicast packet according to the IP addresses of the VTEPs, and send, in a form of the unicast packet, the original packet to all the VTEPs. This can avoid using a multicast manner to perform communication between VTEPs on the VXLAN such that construction of the VXLAN no longer depends on a multicast group quantity or capability of a tunnel end point, which extends application of the VXLAN. Further, in this embodiment, the transmit-end VTEP1 may further report, to a VXLAN centralized controller, an IP address and a MAC address of a virtual machine 1 that are carried by the gratuitous ARP broadcast packet such that the VXLAN centralized controller can acquire a newest correspondence between an IP address and a MAC address of a virtual machine and store the correspondence, which ensures correctness of information in the VXLAN centralized controller, avoids impact on a subsequent procedure, and ensures communication efficiency.

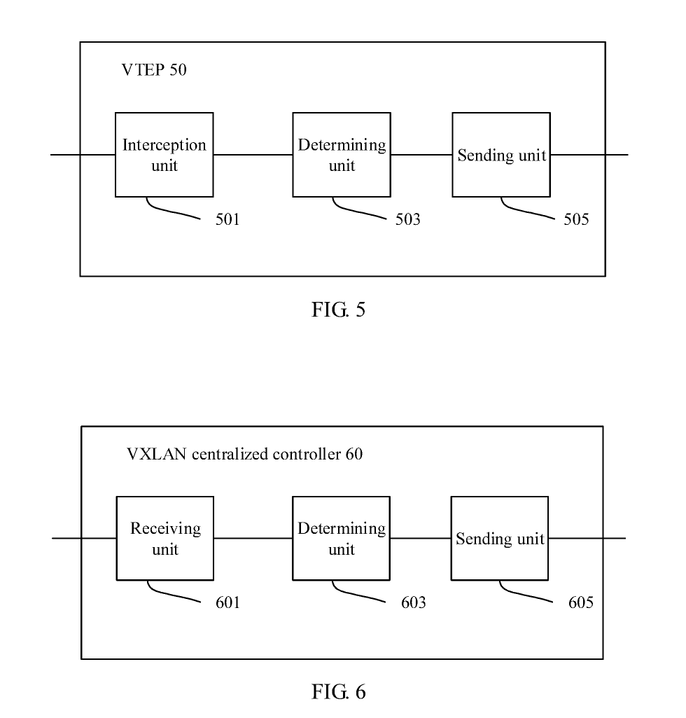

As shown in FIG. 5, an embodiment of the present disclosure provides a VTEP 50 of a VXLAN, where the VXLAN includes a VXLAN centralized controller and multiple VTEPs, and the VTEP 50 includes an interception unit 501 configured to intercept a broadcast packet sent by a transmit-end virtual machine, a determining unit 503 configured to determine whether the broadcast packet does not have a destination address, and if determining that the broadcast packet does not have a destination address, acquire, from the VXLAN centralized controller, an IP address of a receive-end VTEP on the VXLAN if determining that the broadcast packet does not have a destination address, and a sending unit 505 configured to encapsulate the broadcast packet into a unicast packet according to the IP address of the receive-end VTEP, and send the unicast packet to the receive-end VTEP such that the receive-end VTEP broadcasts the received unicast packet to a receive end.

When the broadcast packet is a gratuitous ARP broadcast packet, the sending unit 505 is further configured to report, to the VXLAN centralized controller, a source IP address and a source MAC address that are carried by the gratuitous ARP broadcast packet.

When the broadcast packet is a DHCP broadcast packet, the interception unit 501 is further configured to intercept a response packet sent by a DHCP server in response to the unicast packet, where the response packet carries an IP address assigned by the DHCP server to the transmit-end virtual machine and a MAC address, and the sending unit 505 is further configured to report, to the VXLAN centralized controller, the IP address newly assigned to the transmit-end virtual machine and the MAC address that are acquired by the interception unit 501.

As shown in FIG. 6, an embodiment of the present disclosure provides a VXLAN centralized controller of a VXLAN, where the VXLAN includes a VXLAN centralized controller and multiple VTEPs, and the VXLAN centralized controller 60 includes a receiving unit 601 configured to receive a query request sent by a transmit-end VTEP, where the query request is sent to the VXLAN centralized controller after the transmit-end VTEP intercepts a broadcast packet sent by a transmit-end virtual machine and determines that the broadcast packet does not have a destination address, and the query request carries an identifier of the VXLAN on which the transmit-end VTEP is located, a determining unit 603 configured to determine an IP address of a receive-end VTEP on the VXLAN according to the identifier of the VXLAN, and a sending unit 605 configured to send a query response to the transmit-end VTEP, where the query response carries the IP address of the receive-end VTEP such that the transmit-end VTEP encapsulates the broadcast packet into a unicast packet according to the IP address of the receive-end VTEP, and sends the unicast packet to the receive-end VTEP.

The VXLAN centralized controller 60 further includes a configuration unit configured to pre-configure a correspondence between the identifier of the VXLAN and IP addresses of all VTEPs on the VXLAN, and the determining unit 603 is further configured to query the correspondence according to the identifier of the VXLAN on which the transmit-end virtual machine is located, and determine the IP addresses of all the VTEPs on the VXLAN, and the sending unit 605 is further configured to send a query response to the transmit-end VTEP, where the query response carries the IP addresses of all the VTEPs.

Preferably, the determining unit 603 is further configured to determine a type of the broadcast packet, and obtain, by means of screening according to the type of the broadcast packet or location information of the transmit-end VTEP, multiple receive-end VTEPs from all the VTEPs on the VXLAN.

Further, the broadcast packet is a gratuitous ARP broadcast packet, and the receiving unit 601 is further configured to receive and store a source IP address and a source MAC address that are carried by the gratuitous ARP broadcast packet and that are reported by the transmit-end VTEP, or the broadcast packet is a DHCP broadcast packet, and the receiving unit 601 is further configured to receive and store an IP address assigned by a DHCP server to the transmit-end virtual machine and a MAC address that are reported by the transmit-end VTEP.

With reference to FIG. 1, an embodiment of the present disclosure provides a communications system of a VXLAN, where the VXLAN includes a VXLAN centralized controller and multiple VTEPs, and each VTEP and at least one virtual machine managed by the VTEP form a subnet of the VXLAN, where a transmit-end VTEP is configured to intercept a broadcast packet sent by a transmit-end virtual machine, determine whether the broadcast packet does not have a destination address, and acquire, from the VXLAN centralized controller, an IP address of a receive-end VTEP on the VXLAN, encapsulate the broadcast packet into a unicast packet according to the IP address of the receive-end VTEP, and send the unicast packet to the receive-end VTEP if determining that the broadcast packet does not have a destination address. The VXLAN centralized controller is configured to receive a query request sent by the transmit-end VTEP, determine the IP address of the receive-end VTEP on the VXLAN, and send a query response to the transmit-end VTEP, where the query response carries the IP address of the receive-end VTEP, and the receive-end VTEP is configured to receive the unicast packet sent by the transmit-end VTEP, and broadcast the received unicast packet to a receive end.

The VXLAN centralized controller is further configured to pre-configure a correspondence between an identifier of the VXLAN and IP addresses of all VTEPs on the VXLAN, and the VXLAN centralized controller is further configured to query the correspondence according to the identifier of the VXLAN on which the transmit-end virtual machine is located, determine the IP addresses of all the VTEPs on the VXLAN, and send a query response to the transmit-end VTEP, where the query response carries the IP addresses of all the VTEPs.

The VXLAN centralized controller is further configured to determine a type of the broadcast packet, and obtain, by means of screening according to the type of the broadcast packet or location information of the transmit-end VTEP, multiple receive-end VTEPs from all the VTEPs on the VXLAN.

Preferably, the broadcast packet is a gratuitous ARP broadcast packet. The transmit-end VTEP is further configured to report, to the VXLAN centralized controller, a source IP address and a source MAC address that are carried by the gratuitous ARP broadcast packet, and the VXLAN centralized controller is configured to receive and store the source IP address and the source MAC address.

Preferably, the broadcast packet is a DHCP broadcast packet. The transmit-end VTEP is further configured to intercept a response packet sent by a DHCP server in response to the unicast packet, where the response packet carries an IP address assigned by the DHCP server to the transmit-end virtual machine and a MAC address, and report, to the VXLAN centralized controller, the IP address newly assigned to the transmit-end virtual machine and the MAC address, and the VXLAN centralized controller is further configured to receive and store the IP address newly assigned to the transmit-end virtual machine and the MAC address.

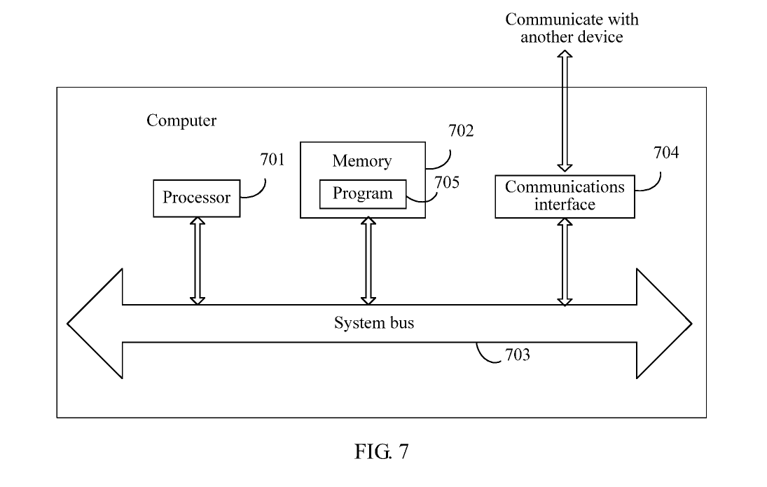

As shown in FIG. 7, FIG. 7 is a structural diagram of composition of a computer according to an embodiment of the present disclosure. The computer in this embodiment of the present disclosure may include a processor 701, a memory 702, a system bus 703, and a communications interface 704. The processor 701, the memory 702, and the communications interface 704 are connected and implement communication with each other using the system bus 703.

The processor 701 may be a single-core or multi-core central processing unit, or an application-specific integrated circuit, or one or more integrated circuits that are configured to implement the embodiment of the present disclosure.

The memory 702 may be a high-speed random-access memory (RAM), or may be a non-volatile memory, such as at least one magnetic disk memory.

The memory 702 is configured to store a program 705. Furthermore, the program 705 may include program code.

When the computer runs, the processor 701 runs the program 705, which may execute the method provided in any embodiment of the embodiments of the present disclosure.

Persons of ordinary skill in the art may understand that, each aspect of the present disclosure or a possible implementation manner of each aspect may be further implemented as a system, a method, or a computer program product. Therefore, each aspect of the present disclosure or a possible implementation manner of each aspect may use forms of hardware only embodiments, software only embodiments (including firmware, resident software, and the like), or embodiments with a combination of software and hardware, which are uniformly referred to as “circuit”, “module”, or “system” herein. In addition, each aspect of the present disclosure or the possible implementation manner of each aspect may take a form of a computer program product, where the computer program product refers to computer readable program code stored in a computer readable medium.

The computer readable medium may be a computer readable signal medium or a computer readable storage medium. The computer readable storage medium includes but is not limited to an electronic, magnetic, optical, electromagnetic, infrared, or semi-conductive system, device, or apparatus, or any appropriate combination thereof, such as a RAM, a read-only memory (ROM), an erasable programmable read only memory (EPROM or flash memory), an optical fiber, and a compact disc read only memory (CD-ROM).

A processor in a computer reads computer readable program code stored in a computer readable medium such that the processor can perform a function and an action specified in each step or a combination of steps in a flowchart. An apparatus is generated to implement a function and an action specified in each block or a combination of blocks in a block diagram.

All computer readable program code may be executed on a user computer, or some may be executed on a user computer as a standalone software package, or some may be executed on a computer of a user while some is executed on a remote computer, or all the code may be executed on a remote computer or a server. It should also be noted that, in some alternative implementation solutions, each step in the flowcharts or functions specified in each block in the block diagrams may not occur in the illustrated order. For example, two consecutive steps or two blocks in the illustration, which are dependent on an involved function, may in practice be executed substantially at the same time, or these blocks may sometimes be executed in reverse order.

What is claimed is:

1. A communication method of a virtual extensible local area network (VXLAN), wherein the VXLAN comprises a VXLAN centralized controller and multiple tunnel end points (VTEPs), and wherein the method comprises:
intercepting, by a transmit-end VTEP, a broadcast packet sent by a transmit-end virtual machine;
determining, by the transmit-end VTEP, whether the broadcast packet does not have a destination address;
acquiring, by the transmit-end VTEP, from the VXLAN centralized controller, an Internet Protocol (IP) address of a receive-end VTEP on the VXLAN when the broadcast packet does not have the destination address;
encapsulating, by the transmit-end VTEP, the broadcast packet into a unicast packet according to the IP address of the receive-end VTEP; and
sending the unicast packet to the receive-end VTEP such that the receive-end VTEP broadcasts the received unicast packet to a receive end.

2. The method according to claim 1, wherein acquiring, by the transmit-end VTEP, from the VXLAN centralized controller, the IP address of the receive-end VTEP on the VXLAN comprises:
sending, by the transmit-end VTEP, a query request to the VXLAN centralized controller; and
receiving, by the transmit-end VTEP, a query response returned by the VXLAN centralized controller, wherein the query response carries IP addresses of all VTEPs on the VXLAN.

3. The method according to claim 1, wherein acquiring, by the transmit-end VTEP, from the VXLAN centralized controller, the IP address of the receive-end VTEP on the VXLAN comprises:
sending, by the transmit-end VTEP, a query request to the VXLAN centralized controller; and
receiving, by the transmit-end VTEP, a query response returned by the VXLAN centralized controller, wherein the query response carries IP addresses of multiple receive-end VTEPs on the VXLAN, and wherein the multiple receive-end VTEPs are obtained by the VXLAN centralized controller from all VTEPs on the VXLAN by means of screening according to a type of the broadcast packet.

4. The method according to claim 1, wherein acquiring, by the transmit-end VTEP, from the VXLAN centralized controller, the IP address of the receive-end VTEP on the VXLAN comprises:
sending, by the transmit-end VTEP, a query request to the VXLAN centralized controller; and
receiving, by the transmit-end VTEP, a query response returned by the VXLAN centralized controller, wherein the query response carries IP addresses of multiple receive-end VTEPs on the VXLAN, and wherein the multiple receive-end VTEPs are obtained by the VXLAN centralized controller from all VTEPs on the VXLAN by means of screening according to location information of the transmit-end VTEP.

5. The method according to claim 1, wherein the broadcast packet is a gratuitous address resolution protocol (ARP) broadcast packet, and wherein the method further comprises reporting, by the transmit-end VTEP, to the VXLAN centralized controller, a source IP address and a source media access control (MAC) address that are carried by the gratuitous ARP broadcast packet.

6. The method according to claim 1, wherein the broadcast packet is a dynamic host configuration protocol (DHCP) broadcast packet, and wherein the method further comprises:
intercepting, by the transmit-end VTEP, a response packet sent by a DHCP server in response to the unicast packet, wherein the response packet carries the IP address assigned by the DHCP server to the transmit-end virtual machine and a media access control (MAC) address; and
reporting, by the transmit-end VTEP, to the VXLAN centralized controller, the IP address newly assigned to the transmit-end virtual machine and the MAC address.

7. A communication method of a virtual extensible local area network (VXLAN), wherein the VXLAN comprises a VXLAN centralized controller and multiple tunnel end points (VTEPs), and wherein the method comprises:
receiving, by the VXLAN centralized controller, a query request sent by a transmit-end VTEP, wherein the query request is sent to the VXLAN centralized controller after the transmit-end VTEP intercepts a broadcast packet sent by a transmit-end virtual machine and determines that the broadcast packet does not have a destination address, and wherein the query request carries an identifier of the VXLAN on which the transmit-end VTEP is located;
determining, by the VXLAN centralized controller, an internet protocol (IP) address of a receive-end VTEP on the VXLAN according to the identifier of the VXLAN; and
sending, by the VXLAN centralized controller, a query response to the transmit-end VTEP, wherein the query response carries the IP address of the receive-end VTEP such that the transmit-end VTEP encapsulates the broadcast packet into a unicast packet according to the IP address of the receive-end VTEP, and send the unicast packet to the receive-end VTEP.

8. The method according to claim 7, further comprising:
pre-configuring, by the VXLAN centralized controller, a correspondence between the identifier of the VXLAN and IP addresses of all VTEPs on the VXLAN;
querying, by the VXLAN centralized controller, the correspondence according to the identifier of the VXLAN;
determining the IP addresses of all the VTEPs on the VXLAN; and
sending the query response to the transmit-end VTEP, wherein the query response carries the IP addresses of all the VTEPs.

9. The method according to claim 8, wherein after determining the IP addresses of all the VTEPs on the VXLAN, the method further comprises:
determining, by the VXLAN centralized controller, a type of the broadcast packet; and
obtaining, by means of screening according to the type of the broadcast packet, multiple receive-end VTEPs from all the VTEPs on the VXLAN.

10. The method according to claim 8, wherein after determining the IP addresses of all the VTEPs on the VXLAN, the method further comprises:
determining, by the VXLAN centralized controller, a type of the broadcast packet; and
obtaining, by means of screening according to location information of the transmit-end VTEP, multiple receive-end VTEPs from all the VTEPs on the VXLAN.

11. The method according to claim 7, wherein the broadcast packet is a gratuitous address resolution protocol (ARP) broadcast packet, and wherein the method further comprises:
receiving, by the VXLAN centralized controller, a source IP address and a source media access control (MAC) address that are carried by the gratuitous ARP broadcast packet and that are reported by the transmit-end VTEP; and
storing, by the VXLAN centralized controller, the source IP address and the source MAC address.

12. The method according to claim 7, wherein the broadcast packet is a dynamic host configuration protocol (DHCP) broadcast packet, and wherein the method further comprises:
receiving, by the VXLAN centralized controller, the IP address assigned by a DHCP server to the transmit-end virtual machine and a media access control (MAC) address that are reported by the transmit-end VTEP; and
storing, by the VXLAN centralized controller, the IP address newly assigned to the transmit-end virtual machine and the MAC address.

13. A communications system of a virtual extensible local area network (VXLAN), comprising:
a VXLAN centralized controller; and
multiple tunnel end points (VTEPs),
wherein each VTEP and at least one virtual machine managed by the VTEP form a subnet of the VXLAN,
wherein a transmit-end VTEP is configured to:
intercept a broadcast packet sent by a transmit-end virtual machine;
determine whether the broadcast packet does not have a destination address;
acquire, from the VXLAN centralized controller, an Internet Protocol (IP) address of a receive-end VTEP on the VXLAN when the broadcast packet does not have the destination address;
encapsulate the broadcast packet into a unicast packet according to the IP address of the receive-end VTEP; and
send the unicast packet to the receive-end VTEP,
wherein the VXLAN centralized controller is configured to:
receive a query request sent by the transmit-end VTEP;
determine the IP address of the receive-end VTEP on the VXLAN; and
send a query response to the transmit-end VTEP, wherein the query response carries the IP address of the receive-end VTEP, and
wherein the receive-end VTEP is configured to:
receive the unicast packet sent by the transmit-end VTEP; and
broadcast the received unicast packet to a receive end.

14. The system according to claim 13, wherein the VXLAN centralized controller is further configured to:
pre-configure a correspondence between an identifier of the VXLAN and IP addresses of all VTEPs on the VXLAN;
query the correspondence according to the identifier of the VXLAN on which the transmit-end virtual machine is located;
determine the IP addresses of all the VTEPs on the VXLAN; and
send the query response to the transmit-end VTEP, wherein the query response carries the IP addresses of all the VTEPs.

15. The system according to claim 14, wherein the VXLAN centralized controller is further configured to:
determine a type of the broadcast packet; and
obtain, by means of screening according to the type of the broadcast packet or location information of the transmit-end VTEP, multiple receive-end VTEPs from all the VTEPs on the VXLAN.

16. The system according to claim 13, wherein the broadcast packet is a gratuitous address resolution protocol (ARP) broadcast packet, wherein the transmit-end VTEP is further configured to report, to the VXLAN centralized controller, a source IP address and a source media access control (MAC) address that are carried by the gratuitous ARP broadcast packet, and wherein the VXLAN centralized controller is further configured to receive the source IP address and the source MAC address.

17. The system according to claim 13, wherein the broadcast packet is a dynamic host configuration protocol (DHCP) broadcast packet, wherein the transmit-end VTEP is further configured to:
intercept a response packet sent by a DHCP server in response to the unicast packet, wherein the response packet carries the IP address assigned by the DHCP server to the transmit-end virtual machine and a media access control (MAC) address; and
report, to the VXLAN centralized controller, the IP address newly assigned to the transmit-end virtual machine and the MAC address, and
wherein the VXLAN centralized controller is further configured to receive the IP address newly assigned to the transmit-end virtual machine and the MAC address.

18. A communications apparatus of a virtual extensible local area network (VXLAN), comprising:
a processor; and
a memory coupled to the processor,
wherein the memory comprises a plurality of instructions stored thereon, that when executed by the processor, cause the processor to:
intercept a broadcast packet sent by a transmit-end virtual machine;
determine whether the broadcast packet does not have a destination address;
acquire, from a VXLAN centralized controller, an Internet Protocol (IP) address of a receive-end tunnel end point (VTEP) on the VXLAN when the broadcast packet does not have the destination address;
encapsulate the broadcast packet into a unicast packet according to the IP address of the receive-end VTEP; and
send the unicast packet to the receive-end VTEP such that the receive-end VTEP broadcasts the received unicast packet to a receive end.

19. The apparatus according to the claim 18, wherein the broadcast packet is a gratuitous address resolution protocol (ARP) broadcast packet, and wherein the instructions further cause the processor to report, to the VXLAN centralized controller, a source IP address and a source media access control (MAC) address that are carried by the gratuitous ARP broadcast packet.

20. The communications apparatus according to claim 19, wherein the broadcast packet is a dynamic host configuration protocol (DHCP) broadcast packet, and wherein the instructions further cause the processor to:
intercept a response packet sent by a DHCP server in response to the unicast packet, wherein the response packet carries the IP address assigned by the DHCP server to the transmit-end virtual machine and a MAC address; and
report, to the VXLAN centralized controller, the IP address newly assigned to the transmit-end virtual machine and the MAC address that are acquired.
